(19) United States
(12) Patent Application Publication
(10) Pub. No.: US 2007/0276703 A1
(43) Pub. Date: Nov. 29, 2007

(54) Integrated Enrollment System and Method

(76) Inventors: Delbert Mason, Murray, UT (US); Jill H. Bischoff, Salt Lake City, UT (US); Gary N. Harding, Centerville, UT (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/561,143

(22) Filed: Nov. 17, 2006

Related U.S. Application Data
(60) Provisional application No. 60/737,479, filed on Nov. 17, 2005.

(51) Int. Cl. G06Q 40/00

(52) U.S. Cl. 705/4

(57) ABSTRACT

A system for providing an integrated enrollment process for a health plan and a health savings account includes a processor for generating a user interface to enable a user to access an integrated enrollment process for enrollment into a health plan and a health savings account by entering health plan enrollment data and health savings account enrollment data. Data storage is provided for storing the health plan enrollment data and the health savings account enrollment data received by the processor. The processor provides the health plan data to a health plan administration system to initiate enrollment of the user into a health plan and provides the health savings account data to a health savings account administration system to initiate opening of a health savings account for the user. A method for providing an integrated enrollment process involves providing an integrated enrollment procedure for enrollment in a health plan and a health savings vehicle, receiving and processing health plan and health savings vehicle enrollment data, and initiating a health plan and a health savings vehicle opening process using the received health plan and health savings vehicle enrollment data.

### CROSS REFERENCE TO RELATED APPLICATION(S)

The present invention claims priority to U.S. Provisional Patent Application No. 60/737,479, filed on Nov. 17, 2005, which is herein incorporated by reference in its entirety.

### FIELD OF THE INVENTION

The present invention relates to integrating healthcare plan enrollment and healthcare payment enrollment processes.

### BACKGROUND

Healthcare consumers enrolled in a health plan may manage their healthcare resources using savings accounts. For example, for a high deductible health plans (HDHPs), a consumer can manage their healthcare resources using health savings accounts (HSAs), in which taxable and nontaxable resources may be deposited and used to pay for healthcare expenses.

HSAs are typically configured to allow a consumer access to their HSA funds in order to reimburse healthcare providers for medical services received that are not covered by the HDHP. For example, a consumer buying a HDHP having a $5000 deductible may open an HSA to deposit $5000 in funds per year that will be used to pay for medical services received up to the $5000 deductible per year. If the $5000 deposited in the HSA is not consumed within the year, the excess typically is retained for future savings. HSAs can provide advantages to consumers because tax benefits may result from certain state and federal income tax liabilities.

A variety of HSA enrollment processes are available to consumers. For enrollment in an HSA, a consumer may be required to be present at the financial institution administering the HSA in order to sign an enrollment form, or a consumer may be required to send to the financial institution an enrollment form with a wet signature. This may cause HSA enrollment processes to be slow or be difficult for a consumer to complete because of the consumer's location or because they may not be immediately available to provide their signature. As a result, the amount of time a consumer is required to wait before HSA funds can be deposited into the account may be lengthy.

Further, due to certain regulatory constraints that protect consumers' rights to access HSA funds, HSA enrollment and HDHP enrollment are separate processes. In addition, in most instances, in order to complete enrollment in an HSA, a consumer is required to indicate that they are enrolled in an HDHP.

As a result, barriers associated with HSA enrollment make the enrollment process cumbersome, and consumers may not be able to effectively manage their healthcare resources.

Therefore, there is a need for a way for consumers to enroll in an HDHP and an HSA so that HSA funds can be deposited without delay and used to pay for expenses not covered under the HDHP.

### SUMMARY

A system and method for providing an integrated enrollment process enables consumers to enroll in a health plan and a health savings vehicle in a single process. The integrated process creates an enrollment process that is easy for the consumer to complete. In addition, the integrated process creates an easy way for a consumer to manage their healthcare resources.

Certain implementations allow a consumer to enroll in a health plan, such as an HDHP, and select and enroll in a tax-favored account (TFA), such as a health savings account or a healthcare reimbursement arrangement, in a single process without requiring a wet signature. Thus, after a consumer communicates their intent to enroll in a TFA, the enrollee's TFA is opened and may receive funds within a short period of time, rather than delaying opening and funding of the enrollee's TFA until after receipt of a wet signature. In further implementations, a consumer affirms their intent to enroll in a TFA, e.g., via electronic affirmation, during the integrated enrollment process in order for the TFA to receive deposited funds.

A system for providing an integrated enrollment process may include a processor coupled to one or more health savings administration systems, one or more health plan administration systems, and data storage, wherein the processor provides a user interface, for example, a website accessible by a browser, through which a user may access an integrated enrollment process to enable the user to enroll both in a health plan and a health savings account (or similar health savings financial vehicle). The user's integrated enrollment data is received by the processor, stored, and transmitted to the health savings administration system(s) and the health plan administration system(s) to enable these systems to open a health savings account for the user and enroll the user in a health plan. The processor may receive confirmation or other data from the health savings administration system and/or the health plan administration system, which is stored by the processor and may be transmitted to the user interface for display to the user.

In some implementations of the system, the user may also use the user interface to obtain information on existing health plan enrollments and/or health savings account status information; to re-enroll in existing health plans or continue existing health savings accounts; to perform management functions relating to the user's health savings account(s) and/or health plan; to update user information; and/or for other uses as desired by implementers of the system.

A method for providing an integrated enrollment process may include providing an integrated enrollment procedure for enrollment in a health plan and a health savings vehicle; receiving and processing health plan and health savings vehicle enrollment data; and initiating a health plan and a health savings vehicle opening process using the received health plan and health savings vehicle enrollment data.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a diagram of an exemplary system for providing an integrated enrollment process.

FIG. 1A is a flowchart of a method for providing an integrated enrollment process.

FIG. 2 is a flowchart of a method for providing an online integrated enrollment process.

FIG. 3 is an illustration of a method for providing HDHPs and HSAs to enrollees via a batch enrollment process.

FIG. 4 is an illustration of various implementations of integrated health plan/health savings account enrollment processes.

FIG. 5 is an illustration of an exemplary system for facilitating an integrated enrollment process.

### DETAILED DESCRIPTION

Systems and methods that integrate health plan and health savings vehicle enrollment processes are provided in order to give consumers easy access to healthcare resources.

It will be understood that the systems and methods for facilitating enrollment into health plans and health savings vehicles are flexible and applicable to a broad range of employers and financial institutions. For present purposes, employers may include, for example, for profit companies such as retailers, mortgage companies, and insurance agencies, and not-for profit companies such as utility companies, and governmental institutions. Savings account administrators, such as tax favored account (TFA) administrators, may be a bank, a bank affiliate, or other financial entities.

In addition, for present purposes, a TFAs may include health savings accounts, health retirement accounts, and/or health reimbursement accounts, and may be implemented in various ways. For example, the TFA may be implemented as a trust for the benefit of the designated beneficiaries, where funds deposited in the trust may be set aside for payment of future medical expenses, and the beneficiaries may be covered by a health plan (e.g., an HDHP). Alternatively, the TFA may be implemented as an account or a plan in which funds are set aside to pay, at least in part, for health plan premiums and other costs of maintaining coverage plus medical expenses up to the deductible amount, where any balance is retained for savings.

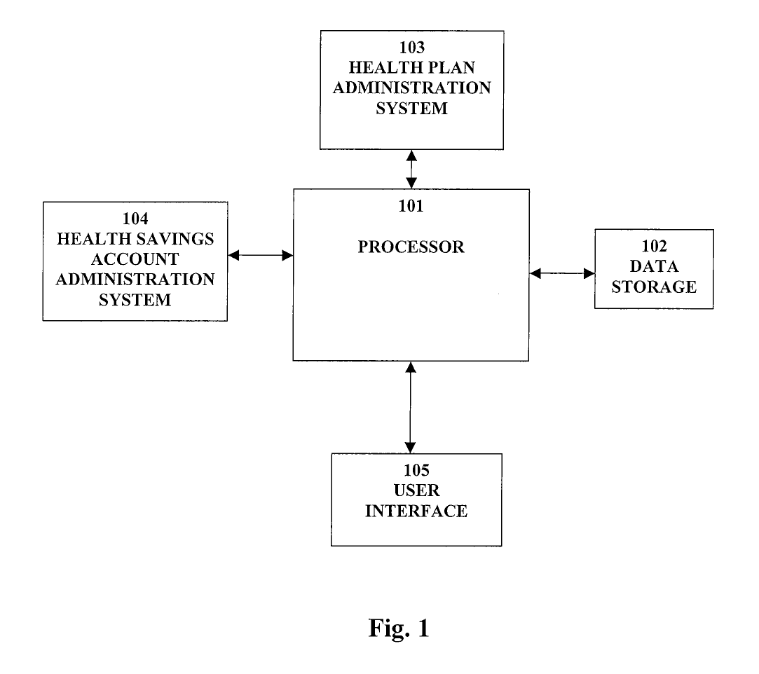

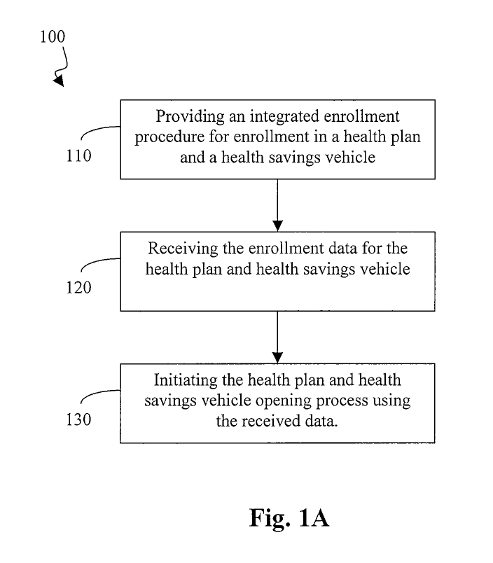

FIG. 1 provides a diagram of a system for providing an integrated enrollment procedure to enable a user to use a single interface to enroll in a health plan and a health savings account (or other health savings financial vehicle). The system includes a processor 101 that communicates (via secure communication methods) with data storage component 102, one more or more health plan administration systems 103, one or more health savings account administration systems 104, and one or more user interface devices 105. Notably, the system may be implemented in a hub configuration with the processor located at a central location, or may be implemented as a distributed network of components.

The processor 101 generates and transmits data to create a user interface, such as a website or other electronic user interface, that enables a user to access an integrated enrollment process to enable the user to enroll in both a health plan and a health savings account. The user accesses the interface at a user interface access device 105 (e.g. computer, PDA, or other remote device) and enters health plan enrollment data and health savings account enrollment data. The data is transmitted to the processor 101, which stores the data in storage 102 and forwards the appropriate data to the health plan administration system 103 and the health savings account administration system 104. The health plan system 103 and/or the health savings account administration system 104 may send back confirmation data or other data to the processor 101 for storage in storage 102 and/or for transmission to the user interface device 105 for display to the user.

The processor 101 may further provide a user interface that enables the user to obtain information on existing health plan enrollments and/or health savings account status information; to re-enroll in existing health plans or continue existing health savings accounts; to perform management functions relating to the user's health savings account(s) and/or health plan; to update user information; and/or for other uses as desired by implementers of the system.

FIG. 1A is a flowchart of a method 100 for providing an integrated enrollment process. Method 100 involves providing 110 an integrated enrollment procedure for enrollment in a health plan and a health savings vehicle, receiving 120 the enrollment data for the health plan and health savings vehicle, and initiating 130 the health plan and health saving vehicle opening process using the received data. In some implementations, where enrollment information for the health plan and the health savings vehicle overlap, the integrated enrollment procedure allows a user to enter the overlapping enrollment data once. For example, a user's personal or demographic data may be required for each of the health plan and the health savings vehicle, and after a user enters this information once, the integrated enrollment procedure may automatically fill other data fields requiring the same information.

The integrated enrollment procedure may further involve an affirmation process that allows an individual to affirm their intent to enroll or re-enroll in the health plan and/or the health savings vehicle. The affirmation process may also involve providing an individual with terms and conditions associated with the health plan or the health savings vehicle. For example, terms and conditions for HSA enrollment may be provided for an individual to review, and an affirmation may be received from individual indicating that the terms and conditions of the HSA are understood. In further configurations, affirmation may consist of a number of parts including acceptance of the terms and conditions of the financial institution implementing the HSA, acknowledging a fee schedule, and/or communicating to the financial institution the enrollee's acceptance of any or all of the above parts.

According to some configurations, a financial institution may receive enrollee affirmations for health savings vehicles in batches. In other configurations, the HSA or other funding vehicle administrator may receive affirmations on an enrollee-by-enrollee basis. Batch enrollment may be implemented, for example, by an employer that expects to have a large number of employees open a savings vehicle or may submit all enrollment information at the end of an enrollment period, for example. Alternatively, enrollees' files may be sent to the financial institution immediately.

According to certain implementations, because the integrated process integrates health plan and health savings vehicle enrollment, the two may be associated automatically once the health savings vehicle is opened. For example, an employer or vendor may associate the enrollee's health plan and health savings vehicle.

The implementations described below involve integrated processes for HDHP and TFA enrollment. However, it will be understood by those skilled in the art that the integrated enrollment process may provide an enrollment vehicle for a variety of health pans or savings plans in addition to or as an alternative to HDHPs and TFAs.

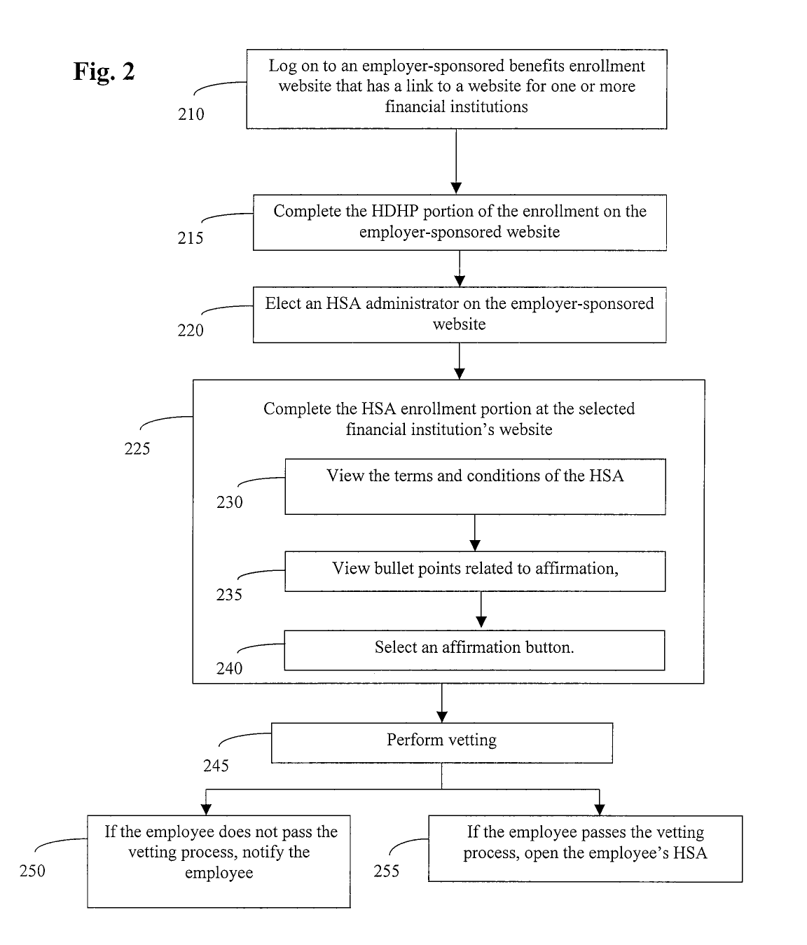

FIG. 2 is a flowchart of a method for providing an online integrated enrollment process according to one implementation. According to FIG. 2, an employee logs on to an employer-sponsored benefits enrollment website 210 that has a link to a website for one or more financial institutions. The employee completes an integrated HDHP and HSA application electronically by completing 215 the HDHP portion of the enrollment and selecting 220 the HSA administrator on the employer-sponsored website, and completing 225 the HSA enrollment portion at the selected financial institution's website. Completing 225 the HSA enrollment portion of the integrated enrollment process may involve viewing 230 the terms and conditions of the HSA, viewing 235 bullet points related to affirmation, and selecting 240 an affirmation button. Vetting occurs 245, which is a process in which an enrollee's enrollment file with information such as the enrollee's name, social security number, date of birth, and address is forwarded from an employer or insurance company to a vendor that screens the enrollee's information and verifies that the enrollee's identity. The KYC/OFAC procedure is an example of vetting.

If the employee does not pass the vetting process, the method includes notifying 250 the employee. In this case, notifying 250 may include requesting that the enrollee verify their identity by providing a copy of their social security card, a birth certificate, and/or a utility bill. If the enrollee submits the information, and their identity is subsequently confirmed, then the enrollee passes the vetting process and the method includes the financial institution opening 255 the employee's HSA. If the employee passes the vetting process after the initial screening process, the method includes the financial institution opening 255 the employee's HSA so that it is ready to accept funds. In some instances, once the HSA is opened, the financial institution may notify the employer so that any additional processing may be completed.

In particular configurations, an employer provides a web-based product to an employee via, for example, an employer-supported website that enables employees to enroll in a HDHP, select a desired HSA, and enroll in the HSA. HSA enrollment data may be submitted to the appropriate administrator, such as a bank, as part of the HSA initiation process, and upon vetting, the HSA may receive deposited funds. In addition, the enrollment process also may include an affirmation mechanism that allows the employee to communicate, via the employer-sponsored website, their election to use the financial institution to administer the employee's HSA. In some implementations, an employee affirms to their employer that they accept the terms and conditions, and the employer makes an affirmation to the HSA administrator.

In another example, a financial institution provides a website that allows employees of another employer to log on and enroll in an HDHP and/or an HSA without the requirement of a wet signature. In this example, the HDHP may be selected by the employee's employer, and the HSA and HSA administrator may be selected by the employee, for example, via an affirmation mechanism. In one implementation, an employee chooses an HDHP through workplace options, and then is directed to a HSA administrator website to complete the HSA application and affirm the terms and conditions using an e-signature.

HSA funding typically originates from nontaxable employee earnings that are transmitted automatically into an HSA account for the employee. Individuals also may contribute taxable dollars to their HSA account, for example, by direct deposit, wire transfers, and checks. In addition, HSA funds may originate from employer contributions. HSA funding may be automated so that funds are deposited into the HSA on a periodic basis, e.g., bi-monthly, or funds may be deposited according to an enrollee's preference.

In some implementations, once an HSA is opened, a HSA debit card, checks, or other payment vehicle may be supplied to the enrollee for HSA disbursements. HSAs ready for disbursement upon opening may have safeguards implemented in order to manage the risk of loss. In one example, a cap may be set so that a disbursement may not go above a predetermined dollar amount, e.g. $2000. Additionally or alternatively, any disbursement above a specified dollar amount may be manually reviewed, e.g., disbursement requests for $1000 or more may be manually reviewed. In other alternatives, the HSA may be opened with a hold on disbursements until a wet signature is received. When a wet signature is required, an employee may be prompted to print and sign their completed application at the time of enrollment, or a form may be mailed to the enrollee for their signature and return. Alternatively, the process of obtaining a wet signature may also occur at a later point, such as after a request for a disbursement is received.

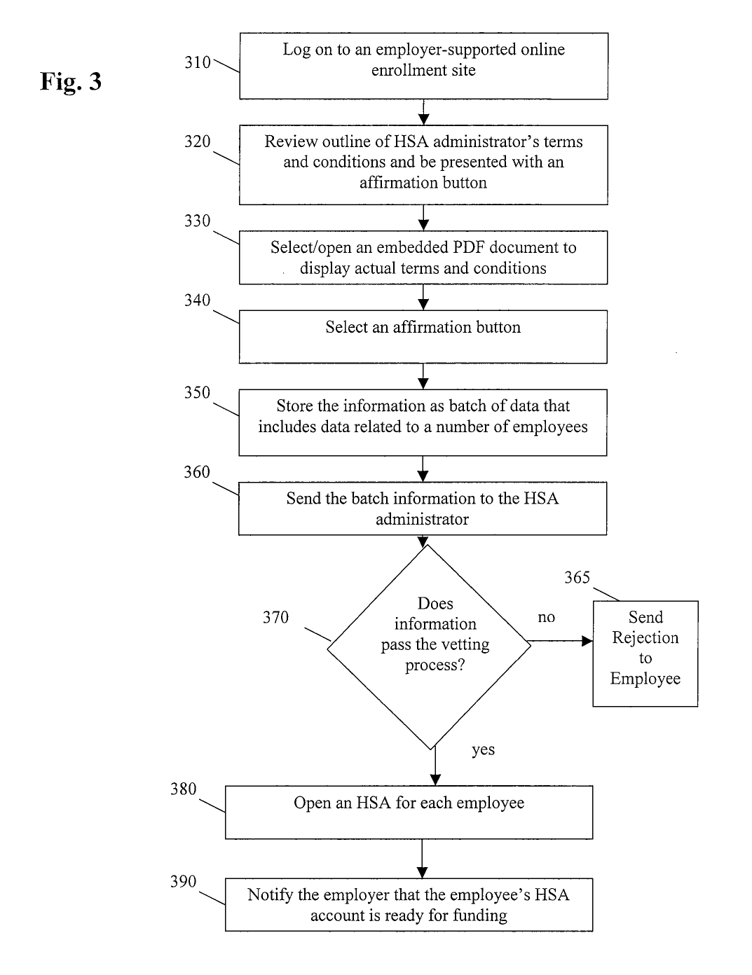

The enrollment process, according to some implementations, may be a batch enrollment process. FIG. 3 is an illustration of a method for providing HDHPs and HSAs to enrollees via a batch enrollment process. An employee logs on at an employer-supported online enrollment site 310, and is presented with an outline of the selected HSA administrator's terms and conditions and an affirmation button 320. In some alternatives, the administrator may require that affirmation points be displayed on an employer's website, which may serve as the outline of the administrators actual terms and conditions. Examples of the affirmation points include the following statements:

By accepting below, I certify that I have read, understand and agree to be bound by the terms and conditions that apply to this, my Health Savings Accounts (HSA) as outlined in the Health Savings Account Schedule of Fees and Charges, HSA Custodial and Deposit Agreement, and Privacy Notice.

I certify that the information provided by me, or on my behalf to my employer, with respect to my HSA is true and complete and I authorize my employer, on my behalf, to provide such information to this HSA administrator. I acknowledge that by accepting below, I have entered into a binding deposit agreement with this HSA administrator.

To help the government fight the funding of terrorism and money laundering activities, federal law requires all financial institutions to obtain, verify and record information that identifies each person who opens an account.

I further acknowledge that upon this administrator's request, to use or maintain my account, I will sign account forms, supply requested information to verify my identity, and take such other steps as may be requested or this HSA administrator may close my account.

The employee selects/opens an embedded PDF document to display 330 the actual terms and conditions the administrator requires of the enrollee. The enrollee then may select an affirmation button 340, and the information is stored 350 by the employer as batch of data that includes data related to a number of employees. The batch information may be sent 360 to the HSA administrator where the information is submitted 370 for vetting. Assuming the employees pass the vetting process, an HSA for each employee is opened 380 ready to receive deposited funds, and in some configurations, an HSA debit card is sent to each employee for disbursing funds from their HSA. The employer also may be notified that the employee's HSA account is ready for funding 390. Otherwise, if one or more employees do not pass the vetting process, the employees failing are notified 365.

Batch enrollment may require that the employer satisfy prerequisites before providing the web-based product to its employees for enrollment in the HSA. For example, the employer may be required to post a financial institution's terms and conditions on the enrollment vehicle, i.e., the employer's internal enrollment website or a vendor's enrollment website. The employer also may be required to collect required employee data and store it in a batch file according to the financial institution's specifications. In addition, the financial institution may provide additional requirements or restrictions such as requiring execution of employer agreements, and/or requiring that the employee's enrollment portion of the website to have all or a portion of the web layout be in accordance with the financial institution's specifications.

Enrollment processes, according to alternative implementations, may occur on an enrollee-by-enrollee basis and may be implemented via an employer-based website, a vendor-based website, or a financial institution's website. For example, an employer and/or financial institution may provide a website for employees to log in to and to complete the integrated enrollment process. This integrated enrollment approach on an enrollee-by-enrollee basis may be useful for employers that do not wish to capture batch information for batch processing or send information to the financial institution.

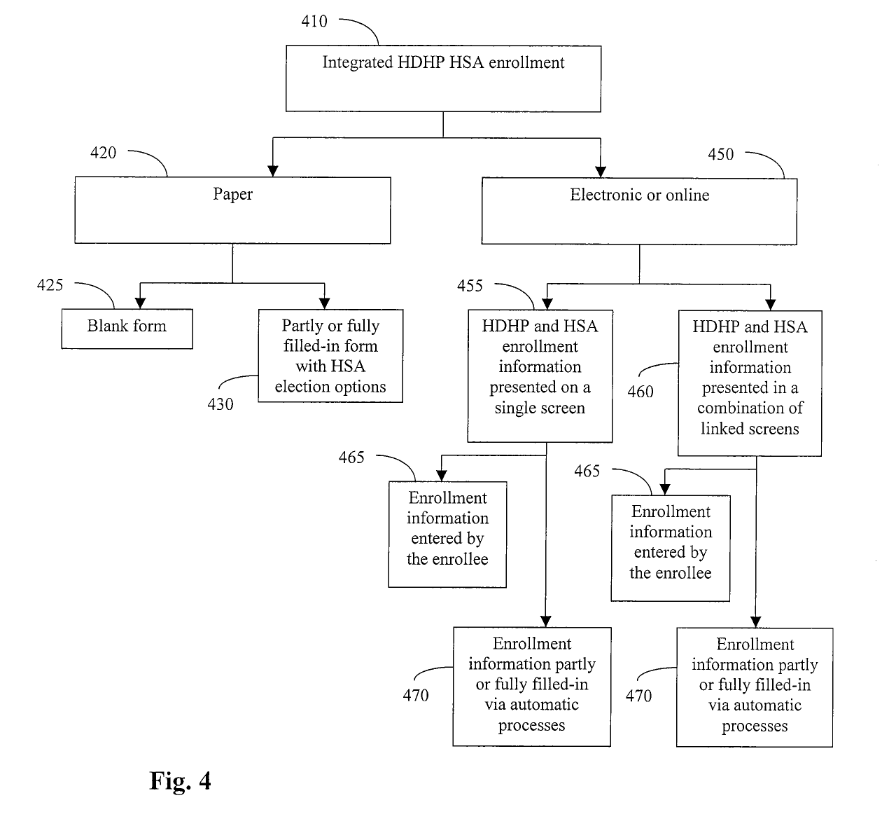

The integrated enrollment process, according to various implementations, may be an electronic enrollment process, a paper process, or combinations thereof. According to FIG. 4, integrated HDHP-HSA enrollment 410 may be a paper 420 process or an electronic or online 450 process. For paper 420 enrollment, HDHP and HSA forms may be provided together. The HDHP and HSA forms may be blank 425 for the enrollee to fill-in, or may be partly or fully filled-in 430, for example, using data from an employer's employee record. For electronic or online 450 enrollment, HDHP and HSA enrollment information may be presented on a single 455 screen, or in a combination of linked screens 460 that provide an integrated online enrollment pathway. Enrollment information may be entered 465 by the enrollee, or may be partly or fully filled-in 470 via automatic processes for both the HDHP and HSA enrollment data.

In some implementations, all of the HDHP enrollment data is provided by the enrollment system, and the HSA enrollment portion of the integrated enrollment process provides HSA administrator selection and an affirmation sections for enrollee completion, and most or all of the rest of the HSA enrollment data is automatically generated so that the enrollee is not required to fill in enrollment data that may be entered erroneously. Alternatively, the enrollee enters the HDHP enrollment data, HSA selection data, affirmation data, and other required HSA enrollment data, and the information entered is compared with employee records as part of a verification or validation process.

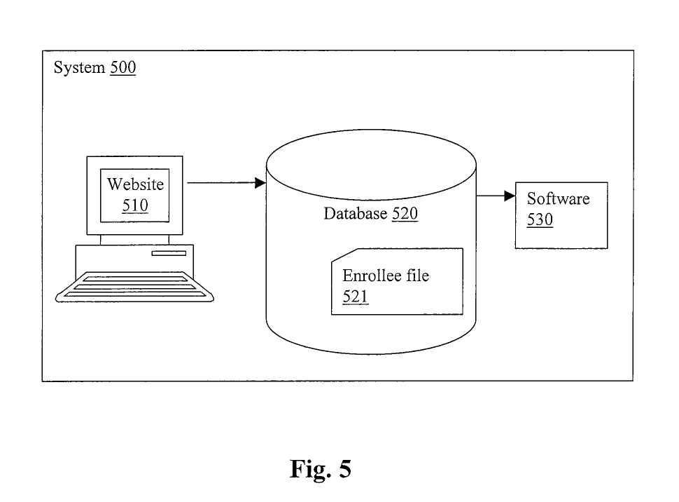

According certain configurations, and as depicted in FIG. 5, a system may facilitate the integrated enrollment process. At a front end of system 500 for implementing integrated enrollment is a website 510 for collecting information. Website may be employer-supported, financial institution-affiliated, or may be a customized website, for example. Information collected may include a variety of information including enrollee information such as: an enrollee's name, social security number, address, date of birth, insurer, group number, individual vs. family coverage, name of the enrollee's health plan, health plan start date, health savings vehicle selected, security information such as mother's maiden name, employer name, and enrollee affirmation. In addition, because the system is provided with a set of enrollee information that is applicable for both the health plan and the health savings vehicle, one set of enrollee information may allow both the health plan and the health savings vehicle to be initiated, and the enrollee does not have to submit redundant information.

Information collected by the system at the front end may be stored in database 520 as an enrollee file 521, and the system software 530 may enable vetting of enrollee files. For example, in order to comply with government laws and regulatory requirements, such as the Patriot Act, the employee file undergoes a “know your customer/office of foreign asset control” (KYC/OFAC) process. In another example, the system collects information about the enrollee from an employer and compares the information received from the enrollee for accuracy as part of a validation process. The back end of system 500 may include databases, software, and communication links to the Internet and/or secure bank or other financial sites. Accordingly, the system may automatically perform the steps and functions necessary to enroll, validate, and make transactions.

As described above, the methods according to the present invention may be implemented using paper, paperless, and/or computer methods. In some implementations, various combinations of software and hardware may be used, as would be apparent to those of skill in the art and as desired by the user. In addition, the present invention may be implemented in conjunction with a general purpose or dedicated computer system having a processor and memory components.

From the above description and drawings, it will be understood by those of ordinary skill in the art that the particular implementations shown and described are for purposes of illustration only and are not intended to limit the scope of the present invention. Those of ordinary skill in the art will recognize that the present invention may be embodied in other specific forms without departing from its spirit or essential characteristics. For example, an integrated enrollment process may be provided so that an enrollee is able to enroll in a health reimbursement account as well as a HDHP and an HSA. In another example, the integrated enrollment process may enable an individual that is self-employed to enroll in a HDHP and HSA. References to details of particular embodiments are not intended to limit the scope of the invention.

What is claimed is:

1. A system for providing an integrated enrollment process for a health plan and a health savings account, comprising:
a processor for generating a user interface to enable a user to access an integrated enrollment process for enrollment into a health plan and a health savings account by entering health plan enrollment data and health savings account enrollment data; and
a data storage component for storing the health plan enrollment data and the health savings account enrollment data received by the processor, wherein the processor provides the health plan data to a health plan administration system to initiate enrollment of the user into a health plan, and
wherein the processor provides the health savings account data to a health savings account administration system to initiate opening of a health savings account for the user.

2. A method for providing an integrated enrollment process comprising:
providing an integrated enrollment procedure for enrollment in a health plan and a health savings vehicle;
receiving and processing health plan and health savings vehicle enrollment data; and
initiating a health plan and a health savings vehicle opening process using the received health plan and health savings vehicle enrollment data.

3. The method of claim 2, wherein providing the integrated enrollment procedure comprises an affirmation procedure for affirming intent to enroll in the health savings vehicle.

4. The method of claim 3, wherein the affirmation procedure comprises:
providing terms and conditions associated with the health savings vehicle; and
receiving an affirmation of understanding of the terms and conditions.

5. The method of claim 2, wherein the health plan is a high deductible health plan.

6. The method of claim 2, wherein the health savings vehicle is a health savings account (HSA).

7. The method of claim 6, wherein receiving comprises receiving HSA enrollment data that comprises HSA administrator selection data, and wherein initiating the HSA opening process comprises sending the HSA enrollment data to the selected HSA administrator.

8. A system for providing an integrated enrollment comprising:
data storage for storing enrollment data; and
a processor for;
providing an integrated enrollment procedure for enrollment in a health plan and a health savings vehicle;
receiving and processing a set of enrollment data for the health plan and the health savings vehicle; and
initiating a health plan and a health savings vehicle opening process using the received set of enrollment data.

9. The system of claim 8, wherein the processor validates the set of enrollment data using an employee database having stored employer data.

10. The system of claim 8, wherein the processor sends the set of enrollment data for the health savings vehicle to a health savings vehicle administrator system.

11. The system of claim 8, wherein the processor sends the set of enrollment data to a vendor to validate the set of enrollment data.

12. The system of claim 8, wherein the receiving and processing the set of enrollment data comprises receiving an processing a batch of enrollment data for a plurality of enrollees.
